(19) United States
(12) Patent Application Publication
(10) Pub. No.: US 2017/0123300 A1
(43) Pub. Date: May 4, 2017

(54) ILLUMINATOR AND PROJECTOR

(71) Applicant: SEIKO EPSON CORPORATION, Tokyo (JP)

(72) Inventor: Yoichi SHISHIDO, Matsumoto-shi (JP)

(73) Assignee: SEIKO EPSON CORPORATION, Tokyo (JP)

(21) Appl. No.: 15/287,474

(22) Filed: Oct. 6, 2016

(30) Foreign Application Priority Data
Oct. 28, 2015 (JP) 2015-211604

(51) Int. Cl. G03B 21/20; G03B 21/00; G02B 5/02; G02B 5/30; G02B 3/00; G02B 27/09

(52) U.S. Cl. CPC G03B 21/208; G03B 21/2073; G02B 3/0062; G03B 21/204; G02B 27/0905; G02B 5/0257; G02B 5/3083; G02B 5/3041; G03B 21/005

(57) ABSTRACT

An illuminator includes a light source apparatus and a homogenizing apparatus. The homogenizing apparatus includes a first lens array in which a plurality of first lenses divide light incident on the first leas array into a plurality of sub-light fluxes and a second lens array in which a plurality of second lenses superimpose the plurality of sub-light fluxes on one another in the illuminated area. The light source apparatus includes a solid-state light source, a wavelength conversion element that converts the wavelength of light emitted from the solid-state light source, and an anisotropic diffusion element that is disposed between the solid-state light source and the wavelength conversion element and changes the shape of the emitted light to a shape according to the shape of an effective area of each of the plurality of second lenses.

### BACKGROUND

1. Technical Field

The present invention relates to an illuminator and a projector.

2. Related Art

There has been a known projector of related art including an illuminator including a solid-state light source that emits excitation light and a wavelength conversion element that emits fluorescence when excited by the excitation light (see JP-A-2015-106130, for example). Specifically, the projector described in JP-A-2015-106130 includes an illuminator including an array light source, a collimator system, an afocal system, a first retardation plate, a prism, a light emitting element (wavelength conversion element), a second retardation plate, a diffusive reflection element, an optical integration system, a polarization conversion element, and a superimposing system.

The array light source has a configuration in which a plurality of semiconductor lasers, each of which is a solid-state light source, are arranged in an array and emits S-polarized blue light, which is a laser beam. The S-polarized blue light is converted by the collimator system into a parallelized light flux, and the diameter of the light flux is adjusted by the afocal system. The polarization axis of the blue light is rotated when the blue light passes through the first retardation plate, which is a half-wave plate, and part of the blue light, which is S-polarized light, is converted into P-polarized light.

Out of the S-polarized light component and the P-polarized light component contained in the blue light described above, the S-polarized light component is reflected off a polarization separation element of the prism, and the P-polarized light component passes through the polarization separation element.

The reflected S-polarized light component is incident as excitation light on a phosphor layer of the light emitting element, whereby yellow fluorescence is produced. The fluorescence is non-polarized light having polarization directions that are not aligned with one another, passes through the polarization separation element with the non-polarized state maintained, and is incident on the optical integration system.

On the other hand, the P-polarized light component contained in the blue light and having passed through the polarization separation element passes through the second retardation plate and diffusively reflected off the diffusive reflection element. The blue light is incident again on the second retardation plate, which converts the blue light into the S-polarized light component, which is reflected off the polarization separation element and incident on the optical integration system.

The optical integration system includes a first lens array having a plurality of first lenses and a second lens array having a plurality of second lenses corresponding to the plurality of first lenses and divides illumination light containing the blue light and fluorescence described above into a plurality of sub-light fluxes, and the optical integration system along with the superimposing system superimposes the plurality of sub-light fluxes on one another in each light modulator, which is an illuminated area. The polarization conversion element is disposed between the optical integration system and the superimposing system and aligns the polarization directions of the sub-light fluxes with one another.

Color light fluxes (image light fluxes) modulated by the light modulators are combined with one another by a combining system, and the combined light is then enlarged and projected by a projection system on a screen.

The polarization conversion element has a configuration in which a polarization separation layer (polarization separation film) and a reflection layer (mirror) are alternately arranged along the direction orthogonal to the optical axis and retardation layers are disposed in the optical paths of the light fluxes having passed through the polarization separation layers or the light reflected off the polarization separation layers and then further reflected off the reflection layers. The focal position of each of the second lenses of the second lens array is so set that the sub-light fluxes are incident on the polarization separation layers. It is noted that there is a known configuration in which a light blocker that covers each of the reflection layers is provided on the light incident side in the polarization conversion element.

A semiconductor laser is characterized in that it emits light the shape of which in a plane orthogonal to the optical axis has an aspect ratio representing a horizontally elongated shape (roughly rectangular shape or roughly elliptical shape). The illumination light described above and produced by the light emitted from the array light source in which semiconductor lasers are arranged in an array also has a shape having the same aspect ratio, and the divided sub-light fluxes from the first lenses described above also have a shape having an aspect ratio representing a horizontally elongated shape on the second lenses.

In a case where each of the thus formed sub-light fluxes is incident on roughly the entire light incident surface of the corresponding second lens, part of the sub-light flux is incident on the second lens, specifically, a portion thereof according to the corresponding reflection layer of the polarization conversion element (in the case where the light blockers are provided, incident on a portion according to the corresponding light blocker). Since the light incident on the portion described above is not used in image formation performed by the light modulators, light loss occurs.

To avoid the light loss, it is conceivable to shorten the distance between the first lens array and the second lens array so that each of the sub-light fluxes from the first lenses is incident on the corresponding second lens, specifically, a roughly square effective area thereat that allows roughly the entire sub-light flux having exited out of the second lens is incident on the corresponding polarization separation layer.

In this case, it is necessary to shorten the distance between the superimposing system and the light modulators so that the sub-light fluxes are appropriately superimposed on one another. However, since the sub-light fluxes are caused to converge by the superimposing system and the convergent sub-light fluxes are incident on the light modulators, the angle of incidence of the light fluxes incident on the light modulators increases. As a result, the angle of emergence of the light that exits out of the light modulators increases, and the amount of image light that does not exit out of the projection optical apparatus increases, undesirably resulting in a decrease in brightness of a projected image.

To solve the problem, it is conceivable to use a homogenizer system having a pair of multi-lens arrays disposed between the first retardation plate and the prism to adjust the shape of the light incident on the light emitting element (wavelength conversion element) in such a way that roughly the entire sub-light fluxes are incident on the effective area described above with no decrease in the distance between the first lens array and the second lens array.

However, since the homogenizer system includes the pair of multi-lens arrays so arranged as to be separate from each other, the configuration of the illuminator undesirably tends to be complicated and hence causes an increase in manufacturing cost.

### SUMMARY

An advantage of some aspects of the invention is to provide an illuminator and a projector capable of improving light use efficiency with the configurations of the illuminator and the projector simplified.

An illuminator according to a first aspect of the invention includes a light source apparatus and a homogenizing apparatus that homogenizes illuminance of light emitted from the light source apparatus in a plane orthogonal to a central axis of the light. The homogenizing apparatus includes a first lens array in which a plurality of first lenses each of which has a shape roughly similar to a shape of an illuminated area are arranged in the orthogonal plane and the plurality of first lenses divide light incident on the first lens array into a plurality of sub-light fluxes and a second lens array in which a plurality of second lenses each of which has a shape roughly similar to the shape of the illuminated area are arranged in the orthogonal plane and the plurality of second lenses superimpose the plurality of sub-light fluxes on one another in the illuminated area. The light source apparatus includes a solid-state light source, a wavelength conversion element that converts a wavelength of light emitted from the solid-state light source, and an anisotropic diffusion element that is disposed between the solid-state light source and the wavelength conversion element and changes a shape of the emitted light to a shape according to a shape of an effective area of each of the plurality of second lenses.

The anisotropic diffusion element is an element capable of adjusting the degree of diffusion of light in at least one of two axes orthogonal to each other in a plane orthogonal to the optical axis to adjust the shape of a light flux that exits out of the anisotropic diffusion element, and examples of the anisotropic diffusion element also include an element capable of individually adjusting the degree of diffusion of light in both the two axes orthogonal to each other. Specific examples of the anisotropic diffusion element may include a hologram, multiple lenses formed of a plurality of lenslets arranged in a plane orthogonal to the optical axis, and a configuration having a roughened surface roughened differently in the two axes orthogonal to each other described above. Among them, the lenslets employed in the multiple lenses can, for example, be lenslets each having the shape of a cylindrical lens.

According to the first aspect described above, the anisotropic diffusion element can change the shape of the light emitted from the solid-state light source and incident on the homogenizing apparatus via the wavelength conversion element to a shape according to the shape of the effective area of each of the second lenses. Therefore, even when the solid-state light source emits light having a shape having an aspect ratio representing a horizontally elongated shape in a plane orthogonal to the optical axis, light having a shape according to the shape of the effective area, that is, light having a shape similar to the shape of the effective area is allowed to enter the first lens array. As a result, the sub-light fluxes produced by the first lenses become light fluxes each having a shape similar to the shape of the effective area, whereby roughly the entire sub-light fluxes are each allowed to enter roughly the entire surface of the effective area without decrease in the distance between the first lens array and the second lens array.

In a case where the illuminator is employed in a projector, and the illuminated area is set in a light modulator of the projector, an increase in the angle of emergence of light having exited out of the light modulator toward a projection optical apparatus can be suppressed, whereby the amount of light that does not enter the projection optical apparatus can be reduced, and a decrease in brightness of a projected image can therefore he suppressed. The light emitted from the light source apparatus can therefore he used with improved efficiency.

Further, in the first aspect, described above, since the anisotropic diffusion element can provide the advantageous effects described above, it is not necessary to employ a homogenizer system having a pair of multi-lens arrays. The configuration of the illuminator can therefore be simplified, whereby the manufacturing cost can be reduced.

In the first aspect described above, it is preferable that the light source apparatus further includes an optical element that causes the light emitted from the solid-state light source to converge and causes the convergent light to enter the anisotropic diffusion element.

The optical element described above can, for example, be a combination of a convex lens and a concave lens that form an afocal system.

According to the configuration described above, since the optical element described above can reduce the light flux diameter of the light incident on the anisotropic diffusion element, the size of the anisotropic diffusion element can be reduced, and the size of each optical element located in the optical path of the light having exited out of the anisotropic diffusion element can be reduced. The size of the illuminator can therefore be reduced.

In the first aspect described above, it is preferable that the homogenizing apparatus includes a polarization conversion element that aligns polarization directions of the plurality of sub-light fluxes with one another, the polarization conversion element has a plurality of polarization separation layers that incline with respect to a first direction that is a direction in which the plurality of sub-light fluxes travel, a plurality of reflection layers that are arranged alternately with the plurality of polarization separation layers along a second direction orthogonal to the first direction, incline with respect to the first direction, and reflect light fluxes reflected off the plurality of polarization separation layers in parallel to a direction in which light fluxes having passed through the plurality of polarization separation layers travel, and a plurality of retardation layers that are provided in optical paths of the light fluxes having passed through the plurality of polarization separation layers or optical paths of the light fluxes having been reflected off the plurality of reflection layers and convert polarization directions of light fluxes incident on the retardation layers, and when the second lens array is viewed from a side facing the first lens array, the effective area is an area that does not overlap with the plurality of reflection layers in each of the plurality of second lenses.

In a case where the polarization conversion element has a plurality of light blocking layers located on the side opposite the first direction side and in the positions corresponding to the plurality of reflection layers, the effective area described above can be alternately referred to as an area in each of the plurality of second lenses that does not overlap with the plurality of reflection layers when the second lens array is viewed from the side facing the first lens array.

According to the configuration described above, the polarization conversion element allows the illuminator to output light having polarization directions aligned with one another, whereby the versatility of the illuminator can be improved.

Since the effective area of each of the second lenses, in accordance with which the anisotropic diffusion element adjusts the shape of light incident thereon, is set as described above, each of sub-light flux is allowed to enter roughly the entire surface of the effective area, whereby roughly the entire sub-light flux having exited out of the second lens are allowed to enter the polarization separation layer without incidence of the sub-light flux on the reflection layer or the light blocking layers. Therefore, light loss can be suppressed, whereby the light use efficiency can be reliably improved.

A projector according to a second aspect of the invention includes the illuminator described above, a light modulator that modulates light emitted from the illuminator, and a projection optical apparatus that projects the modulated light from the light, modulator, and the illuminated area is a modulation area where the light modulator modulates light incident thereon.

The second aspect described above can provide the same advantageous effects as those provided by the illuminator according to the first aspect described above. Since the illuminated area is the modulation areas of the light modulator, the modulation area can be illuminated with light having a uniform illuminance distribution. Brightness unevenness in a projected image can therefore be suppressed. Further, since it is not necessary to shorten the distance between the first lens array and the second lens array, an increase in the angle of emergence of the light that exits out of the light modulator (image light) toward the projection optical apparatus is suppressed. Therefore, a decrease in brightness of a projected image can be suppressed, and the use efficiency of the light from the light source apparatus is improved, whereby the brightness of the projected image can be increased.

### BRIEF DESCRIPTION OF THE DRAWINGS

The invention will be described with reference to the accompanying drawings, wherein like numbers reference like elements.

FIG. 1 is a diagrammatic view showing the configuration of a projector according to an embodiment of the invention.

FIG. 2 is a diagrammatic view showing the configuration of an illuminator in the embodiment.

FIG. 3 is a cross-sectional view diagrammatically showing part of a polarization conversion element in the embodiment.

FIG. 4 shows the positions of overlap areas in a second lens array that overlap with light blockers when the second lens array is viewed from the light incident side in the embodiment.

FIG. 5 is an enlarged view of the positional relationship between a second lens and overlap areas in the embodiment.

FIG. 6 shows the shape of excitation light in a plane orthogonal to the optical axis that is incident on an anisotropic diffusion element in the embodiment.

FIG. 7 shows the shape of the excitation light in a plane orthogonal to the optical axis that exits out of the anisotropic diffusion element in the embodiment.

### DESCRIPTION OF EXEMPLARY EMBODIMENTS

An embodiment of the invention will be described below with reference to the drawings.

### Overall Configuration of Projector

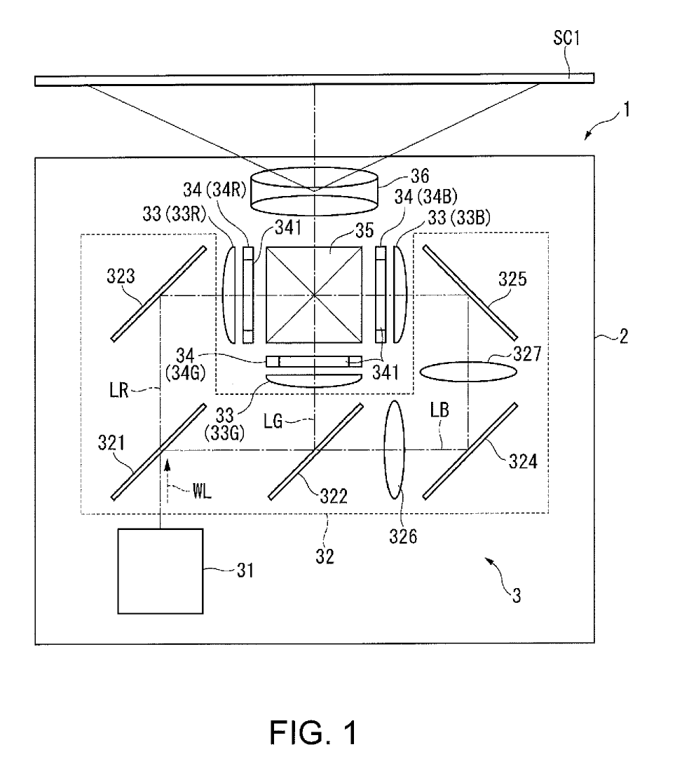

FIG. 1 is a diagrammatic view showing the configuration of a projector 1 according to the present embodiment.

The projector 1 according to the present embodiment is a display apparatus that modulates light emitted from an illuminator 31 provided in the projector 1 to form an image according to image information and enlarges and projects the image on a screen SCI or any other projection surface.

The projector 1, which will be described later in detail, is partly characterized by a function of causing each sub-light flux to enter roughly the entire surface of an effective area AR of a second lens array 52, which forms a homogenizing apparatus 5, by adjusting the shape of the light fluxes incident on the homogenizing apparatus 5 in order to simplify the configuration with the use efficiency of light emitted from a light source increased.

The thus configured projector 1 includes an exterior enclosure 2 and an optical unit 3, which is accommodated in the exterior enclosure 2, as shown in FIG. 1. Although not shown, the projector 1 further includes a controller that controls the projector 1, a cooler that cools components to be cooled, such as optical parts, and power source that supplies electronic parts with electric power.

### Configuration of Optical Unit

The optical unit 3 includes an illuminator 31, a color separation apparatus 32, parallelizing lenses 33, light modulators 34, a light combining apparatus 35, and a projection optical apparatus 36.

Among them, the illuminator 31 outputs illumination light WL. The configuration of the illuminator 31 will be described later in detail.

The color separation apparatus 32 separates the illumination light WL incident from the illuminator 31 into red light LR, green light LG, and blue light LB. The color separation apparatus 32 includes dichroic mirrors 321 and 322, reflection mirrors 323, 324, and 325, and relay lenses 326 and 327.

Among them, the dichroic mirror 321 separates the red light LR and the other color light fluxes (green light LG and blue light LB), which form the illumination light WL, from each other. The separated red light LR is reflected off the reflection mirror 323 and guided to a parallelizing lens 33 (33R). The separated other color light fluxes are incident on the dichroic mirror 322.

The dichroic mirror 322 separates the green light LG and the blue light LB, which form the other color light fluxes, from each other. The separated green light LG is guided to a parallelizing lens 33 (33G). The separated blue light LB travels via the relay lens 326, the reflection mirror 324, the relay lens 337, and the reflection mirror 325 and is guided to a parallelizing lens 33 (33B).

Each of the parallelizing lenses 33 (reference characters 33R, 33G, and 33B denote parallelizing lenses for red light LR, green light LG, and blue light LB, respectively) parallelizes the light incident thereon.

The light modulators 34 (reference characters 34R, 34G, and 34B denote light modulators for red light LR, green light LG, and blue light LB, respectively) modulate the color light fluxes LR, LG, and LB incident thereon to form image light fluxes according to image information. Each of the light modulators 34 includes a liquid crystal panel that modulates a color light flux incident thereon and a pair of polarizers disposed on the light incident side and the light exiting side of the light modulators 34R, 34G, and 34B.

In each of the light modulators 34, a modulation area 341, which is an image formation area that modulates a color light flux incident thereon to form an image, is a modulation area of the liquid crystal panel. The modulator area 341 is an area having an aspect ratio (ratio of length of long side to length of short side) representing a horizontally elongated shape, and the aspect ratio is 16:9 in the present embodiment. The aspect ratio of the modulation area 341 is not limited to the value described above and may be 4:3.

The light combining apparatus 35 combines the image light fluxes incident from light modulators 34R, 34G, and 34B (image light fluxes formed by color light fluxes LR, LG, and LB described above). The light combining apparatus 35 can be formed, for example, of a cross dichroic prism.

The projection optical apparatus 36 projects the image light fluxes combined by the light combining apparatus 35 on the screen SC1 or any other projection surface. As the projection optical apparatus, although not shown, a lens unit in which a plurality of lenses are arranged in a lens barrel can be employed.

The thus configured optical unit 3 projects an enlarged image on the screen SC1.

### Configuration of Illuminator

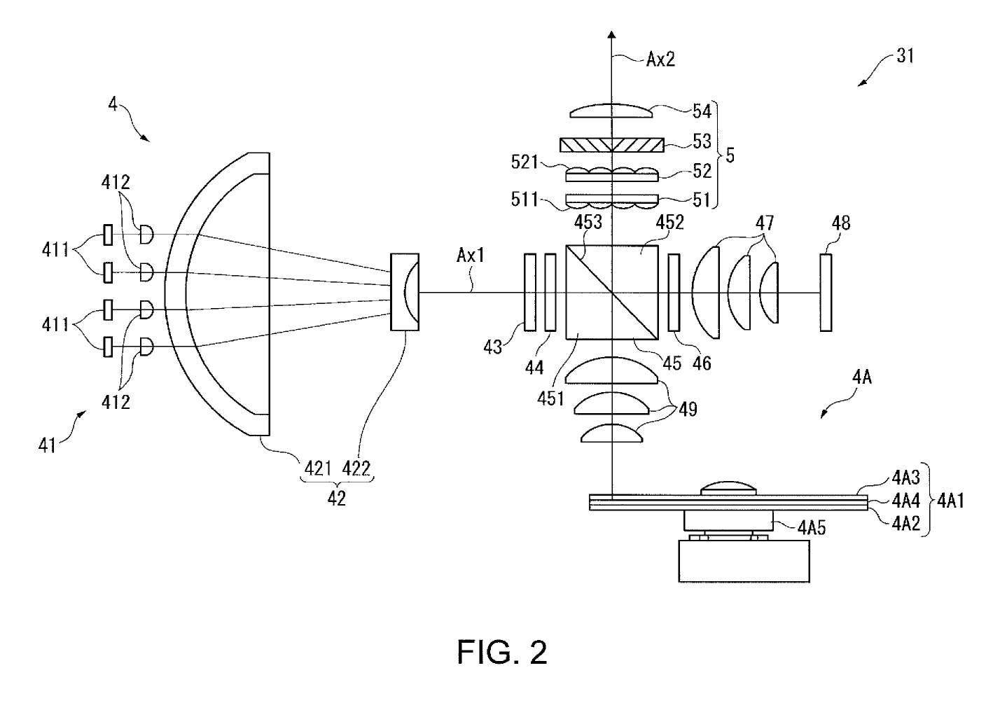

FIG. 2 is a diagrammatic view showing the configuration of the illuminator 31.

The illuminator 31 outputs the illumination light WL toward the color separation apparatus 32, as described above. The illuminator 31 includes a light source apparatus 4 and a homogenizing apparatus 5, as shown in FIG. 2.

### Configuration of Light Source Apparatus

The light source apparatus 4 outputs a light flux to the homogenizing apparatus 5. The light source apparatus 4 includes a light source section 41, an afocal system 42, a first retardation plate 43, an anisotropic diffusion element 44, a polarization separation apparatus 45, a second retardation plate 46, a first pickup lens 47, a diffusive reflection element 48, a second pickup lens 49, and a wavelength conversion apparatus 4A.

Among them, the light source section 41, the afocal system 42, the first retardation plate 43, the anisotropic diffusion element 44, the polarization separation apparatus 45, the second retardation plate 46, the first pickup lens 47, and the diffusive inflection element 48 are arranged along an illumination optical axis Ax1. The polarization separation apparatus 45 is disposed at a point where the illumination optical axis Ax1 intersects an illumination optical axis Ax2, which is orthogonal to the illumination optical axis Ax1.

### Configuration of Light Source Section

The light source, section 41 includes a plurality of solid-state light sources 411, each of which is an LD (laser diode), and a plurality of parallelizing lenses 412 corresponding to the solid-state light sources 411 and outputs excitation light that is blue light toward the afocal system 42. In the present embodiment, each of the solid-state light sources 411 emits excitation light the intensity of which peaks, for example, at a wavelength of 440 nm, but an LD that emits excitation light the intensity of which peaks at a wavelength, of 446 nm may be employed as each of the solid-state light sources 411, or an LD that emits excitation light the intensity of which peaks at a wavelength of 440 nm and an LD that emits excitation light the intensity of which peaks at a wavelength of 446 nm may be mixed with each other. The excitation light emitted from each of the solid-state light sources 411 is parallelized by the parallelizing lens 412 and incident on the afocal system 42. In the present embodiment, the excitation light emitted from each of the solid-state light sources 411 is S-polarized light.

### Configuration of Afocal System

The afocal system 42 adjusts the light flux diameter of the excitation light incident from the light source section 41. Specifically, the afocal system 42 is an optical element that causes the excitation light incident as parallelized light from the light source section 41 to converge so that the light flux diameter decreases, parallelizes the convergent light and outputs the parallelized light. The afocal system 42 includes lenses 421 and 422, which are a convex lens and a concave lens, respectively, and the excitation light emitted from the light source section 41 is caused to converge by the afocal system 42 and incident on the first retardation plate 43 and then the anisotropic diffusion element 44.

### Configuration of First Retardation Plate

The first retardation plate 43 is a half-wave plate. The excitation light, which is S-polarized light emitted from the light source section 41, passes through the first retardation plate 43, which converts part of the S-polarized light into P-polarized light, whereby the excitation light becomes light formed of S-polarized light and P-polarized mixed with each other. Then excitation light having passed through the first retardation plate 43 is incident on the anisotropic diffusion element 44.

### Configuration of Anisotropic Diffusion Element

The anisotropic diffusion element 44 replaces the homogenizer system having a pair of multi-lens arrays described above. The anisotropic diffusion element 44 not only diffuses a light flux incident thereon at diffusion factors different from each other in two axes orthogonal to each other in a plane orthogonal to the optical axis (plane orthogonal to illumination optical axis Ax1) to homogenize the illuminance of the light flux that exits out of the anisotropic diffusion element 44 in the plane orthogonal to the optical axis but also adjusts the shape of the exiting light flux.

The thus functioning anisotropic diffusion element 44 can, for example, have a configuration having a hologram or can, for example, be multiple lenses formed of a plurality of lenslets arranged in a plane orthogonal to the optical axis or a plate-shaped body having a roughened surface roughened differently in the two axes orthogonal to each other described above. Among them, each of the lenslets employed in the multiple lenses can, for example, be a lenslet having the shape of a cylindrical lens.

The shape of the light flux incident on the anisotropic diffusion element 44 and the shape of the light flux that exits out of the anisotropic diffusion element 44 will be described later in detail.

### Configuration of Polarization Separation Apparatus

The polarization separation apparatus 45 is a prism-shaped PBS (polarizing beam splitter), is formed by bonding prisms 451 and 452, each of which is formed in a roughly triangular columnar shape, along surfaces thereof, and therefore has a roughly box-like shape as a whole. The interface between the prisms 451 and 452 is inclined by about 45° with respect to both the illumination optical axes Ax1 and Ax2. In the polarization separation apparatus 45, a polarization separation layer 453 having wavelength selectivity is formed along the interface of the prism 451, which is located on the side facing the anisotropic diffusion element 44 (that is, the side facing the light source section 41).

The polarization separation layer 453 is characterized in that it separates the S-polarized light and the P-polarized light contained in the excitation light from each other. The polarization separation layer 453 further has a function of transmitting fluorescence produced when the excitation light is incident on the wavelength conversion apparatus 4A, which will be described later, irrespective of the polarization state of the fluorescence. That is, the polarization separation layer 453 has a wavelength selective polarization separation characteristic that affects light within a predetermined wavelength region in such a way that S-polarized light and P-polarized light are separated from each other but transmits light within another predetermined wavelength region without S-polarized light and P-polarized light separated from each other.

The thus configured polarization separation apparatus 45, which receives the excitation light incident from the anisotropic diffusion element 44, transmits P-polarized light toward the second retardation plate 46 along the illumination optical axis Ax1 and reflects S-polarized light toward the second pickup lens 49 along the illumination optical axis Ax2.

### Configurations of Second Retardation Plate, First Pickup Lens, and Diffusive Reflection Element

The second retardation plate 46 is a quarter-wave plate and rotates the polarization direction of the excitation light incident from the polarization separation apparatus 45.

The first pickup lens 47 focuses the excitation light having passed through the second retardation plate 46 onto the diffusive reflection element 48. The number of lenses that form the first pickup lens 47 is three in the present embodiment but can be any number.

The diffusive reflection element 48 diffusively reflects the excitation light incident thereon in the same manner the fluorescence is produced by and outputted from a wavelength conversion element 4A1, which will be described later. The diffusive reflection element 48 can, for example, be a reflection member that causes light incident thereon to undergo Lambertian reflection.

The excitation light diffusively reflected off the thus configured diffusive reflection element 48 is incident again on the second retardation plate 46 via the first pickup lens 47. In the process in which the excitation light passes through the second retardation plate 46, the polarization direction of the excitation light is further rotated so that the excitation light is converted into S-polarized excitation light. The excitation light is then reflected off the polarization separation layer 453 of the polarization separation apparatus 45, travels along the illumination optical axis Ax2, and is incident as blue light on the homogenizing apparatus 5.

The second pickup lens 49 and the wavelength conversion apparatus 4A are disposed in the illumination optical axis Ax2 described above.

On the second pickup lens 49 is incident the S-polarized excitation light having passed through the anisotropic diffusion element 44 and having been reflected off the polarization separation layer 453. The second pickup lens 49 focuses the excitation light onto the wavelength conversion element 4A1. The number of lenses that form the second pickup lens 49 is three in the present embodiment but can be any number.

### Configuration of Wavelength Conversion Apparatus

The wavelength conversion apparatus 4A converts the excitation light incident thereon into fluorescence. The wavelength conversion apparatus 4A includes the wavelength conversion element 4A1 and a rotating apparatus 4A5.

Out of the two components, the rotating apparatus 4A5 is formed, for example, of a motor that rotates the wavelength conversion element 4A1 around the central axis thereof.

The wavelength conversion element 4A1 has a substrate 4A2, and a phosphor layer 4A3 and a reflection layer 4A4, which are located on an excitation light incident surface of the substrate 42A.

The substrate 4A2 is formed in a roughly circular shape when viewed from the excitation light incident side. The substrate 4A2 can be made, for example, of a metal or ceramic material.

The phosphor layer 4A3 contains a phosphor that is excited by the excitation light incident thereon and emits fluorescence (fluorescence the intensity of which peaks at a wavelength within a wavelength range, for example, from 500 to 700 nm). Part of the fluorescence produced by the phosphor layer 4A3 exits toward the second pickup lens 49, and another part of the fluorescence exits toward the reflection layer 4A4.

The reflection layer 4A4 is disposed between the phosphor layer 4A3 and the substrate 4A2 and reflects the fluorescence incident from the phosphor layer 4A3 toward the second pickup lens 49.

The fluorescence emitted from the thus configured wavelength conversion element 4A1 is non-polarized light. The fluorescence is incident on the polarization separation layer 453 of the polarization separation apparatus 45 via the second pickup lens 49, passes through the polarization separation layer 453 along the illumination optical axis Ax2, and enters on the homogenizing apparatus 5.

As described above, out of the two components of the excitation light incident on the polarization separation apparatus 45 via the anisotropic diffusion element 44, the P-polarized light is diffused when it is incident on the diffusive reflection element 48, passes through the second retardation plate 46 twice, is reflected off the polarization separation apparatus 45, and enters as blue light the homogenizing apparatus 5. On the other hand, the S-polarized light is converted in terms of wavelength into fluorescence (green light and red light) by the wavelength conversion apparatus 4A, then passes through the polarization separation apparatus 45, and enters the homogenizing apparatus 5. That is, the blue light, the green light, and the red light axe combined with one another by the polarization separation apparatus 45, and the resultant white illumination light WL enters the homogenizing apparatus 5.

### Configuration of Homogenizing Apparatus

The homogenizing apparatus 5 homogenizes the illuminance of the illumination light WL incident from the light source apparatus 4 in a plane orthogonal to the central axis of the illumination light WL (plane orthogonal to optical axis), specifically, homogenizes the illuminance distribution of the light flux in the modulation area 341, which is an illuminated area in each of the light modulators 34 (34R, 34G, and 34B). The homogenizing apparatus 5 includes a first lens array 51, a second lens array 52, a polarization conversion element 53, and a superimposing lens 54.

### Configurations of First Lens Array, Second Lens Array, and Superimposing Lens

The first lens array 51 has a configuration in which a plurality of first lenses 511, each of which is a lenslet, are arranged in a matrix in a plane orthogonal to the optical axis, and the plurality of first lenses 511 divide the illumination light WL incident thereon into a plurality of sub-light fluxes. The lens surface of the first lens array 51 (imaginary surface formed of valleys located between the plurality of first lenses 511 and connected to each other) is conjugate with the modulation area 341 of each of the light modulator 34 via the optical parts. Therefore, the shape of each of the first lenses 511 is similar to the shape of the modulation area 341, and each of the first lenses 511 is formed in a rectangular shape having an aspect ratio representing a horizontally elongated shape in the present embodiment, as in the case of the modulation area 341.

The second lens array 52 has a configuration in which a plurality of second lenses 521, each of which is a lenslet, are arranged in a matrix in a plane orthogonal to the optical axis, as in the case of the first lens array 51, and each of the second lenses 521 is related to the corresponding first lens 511 in the 1:1 relationship. That is, on a second lens 521 is incident a sub-light flux having exited out of the corresponding first lens 511. The second lenses 521 along with the superimposing lens 54 superimpose the plurality of divided sub-light fluxes from the first lenses 511 on one another in the modulation area 341 of each of the light modulators 34. The shape of each of the second lenses 521 is similar to the shape of the corresponding first lens 511.

### Configuration of Polarization Conversion Element

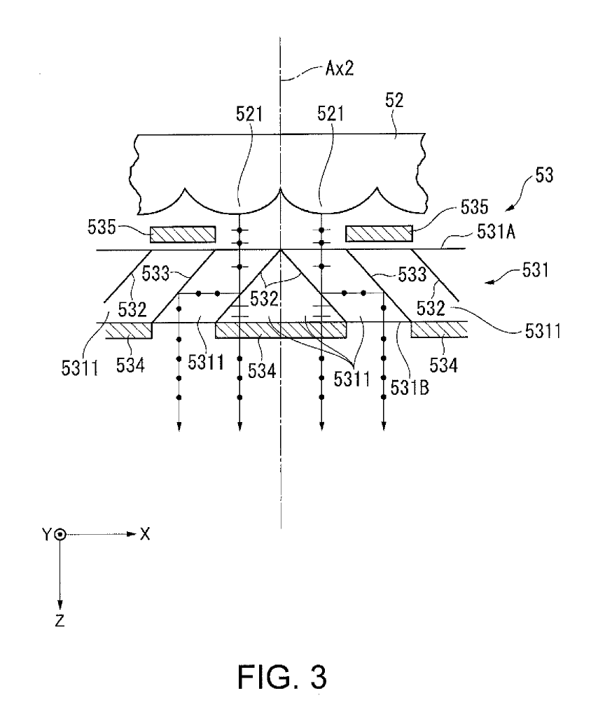

FIG. 3 is a cross-sectional view diagrammatically showing part of the polarization conversion element 53.

The polarization conversion element 53 is disposed between the second lens array 52 and the super-imposing lens 54 and has a function of aligning the polarization directions of the plurality of sub-light fluxes incident on the polarization conversion element 53. The polarization conversion element 53 has a light transmissive member 531, retardation layers 534, and light blockers 535, as shown in FIG. 3.

The light transmissive member 531 has a configuration in which columnar bodies 5311, each of which has a triangular or parallelogram cross-sectional shape, are bonded to each other and is formed in a roughly rectangular-plate-like shape as a whole. The columnar bodies 5311 are made of a light transmissive material that allows the sub-light fluxes described above to pass and is, for example, white glass. A polarization separation layer 532 or a reflection layer 533 is formed on a surface of each of the columnar bodies 5311.

The polarization separation layer 532 and the reflection layer 533 incline by about 45° with respect to a direction Z (first direction), which is not only the direction in which the incident sub-light fluxes travel but also the direction along the illumination optical axis Ax2, and the polarization separation layer 532 and the reflection layer 533 are alternately arranged along a direction X (second direction), which is orthogonal to the direction Z.

Each of the polarization separation layer 532 and the reflection layer 533, although not illustrated in detail, is formed in a rectangular shape having a widthwise direction that coincides with the direction X and a longitudinal direction that coincides with a direction Y, which is orthogonal to the direction X, in a plane orthogonal to the direction Z. Each of the divided sub-light fluxes from the first lens array 51 passes a light incident surface 531A (light incident surface 531A of light transmissive member 531) according to the polarization separation layer 532 corresponding to the sub-light flux and impinges on the polarization separation layer 532.

Each of the polarization separation layers 532 is a layer that transmits one of the P-polarized light and the S-polarized light incident thereon and reflects the other and is formed of a dielectric multilayer film.

Each of the reflection layer 533 reflects the polarized light reflected off the corresponding polarization separation layer 532 in the direction parallel to the direction in which the polarized light having passed through the polarization separation layer 532 travels and directed in the same orientation of the polarized light having passed through the polarization separation layer 532.

The retardation layers 534 are provided on a light exiting surface 531B of the light transmissive member 531. In the present embodiment, the retardation layers 534 are disposed in the optical paths of the polarized light fluxes having passed through the polarization separation layers 532 and rotate the polarization direction of the light fluxes incident on the

retardation layers 534 by 90° to make the polarization direction of the incident polarized light fluxes coincide with the polarization direction of the polarized light fluxed reflected off the polarization separation layers 532. The retardation layers 534 align the polarization directions of the light fluxes that exit out of the polarization conversion element 53 (polarization separation layers 532) with one another.

The retardation layers 534 may be disposed in the optical paths of the polarized light fluxes reflected off the reflection layers 533. That is, in the case where the retardation layers 534 are disposed in the optical paths of the light fluxes having passed through the polarization separation layers 532 and the polarization separation layers 532 are configured to transmit S-polarized light, the sub-light fluxes having exited out of the polarization conversion element 53 are P-polarized light fluxes, whereas the polarization separation layers 532 are configured to transmit P-polarized light, the sub-light fluxes having exited out of the polarization conversion element 53 are S-polarized light fluxes. Instead, in the case where the retardation layers 534 are disposed in the optical paths of the light reflected off the reflection layers 533 and the polarization separation layers 532 are configured to transmit S-polarized light, the sub-light fluxes having exited out of the polarization conversion element 53 are S-polarized light fluxes, whereas the polarization separation layers 532 are configured to transmit P-polarized light, the sub-light fluxes having exited out of the polarization conversion element 53 are P-polarized light fluxes. In any of the cases described above, the light having exited out of the polarization conversion element 53 is polarized light of one type.

The light blockers 535 are made, for example, of stainless, an aluminum alloy, or any other metal and located at a plurality of locations on the light incident side of the light transmissive member 531. Specifically, the light blockers 535 are provided on the light incident side of the light transmissive member 531 and in positions corresponding to the reflection layers 533. The thus provided light blockers 535 are so disposed that the sub-light fluxes having exited out of the second lenses 521 are incident only on the polarization separation layers 532, and light that is likely to be directly incident on the reflection layers 533 is blocked by the light blockers 535. Roughly the entire sub-light fluxes having exited out of the second lenses 521 are therefore incident on the light incident surface 531A that is not covered with the light blockers 535 and then incident on the polarization separation layers 532 described above.

In a case where part of the light having exited out of the second lenses 521 does not greatly affect image formation even if the light is incident on the reflection layers 533, the light blockers 535 may be omitted.

### Effective Areas in Second Lenses

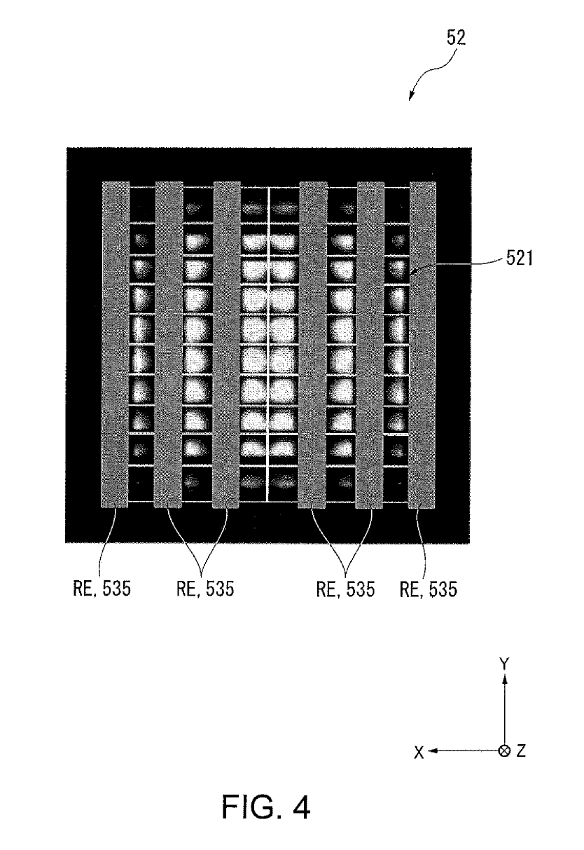

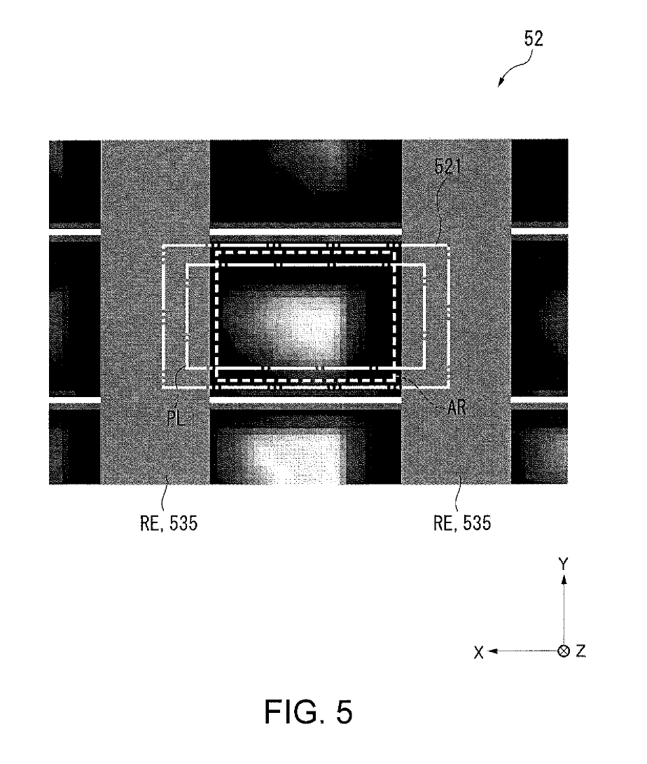

FIG. 4 shows the positions of overlap areas RE in the second lens array 52, which overlap with the light blockers 535 when the second lens array 52 is viewed from the light incident side (side facing first lens array 51). FIG. 5 is an enlarged view of the positional relationship between a second lens 521 and overlap areas RE. In other words, FIG. 5 shows the relationship between the lens shape of each second lens 521 and an effective area AR. In FIGS. 4 and 5, only part of the second lenses 521 is labeled with the reference character in consideration of clarity.

The light blockers 535 described above are disposed in positions corresponding to the reflection layers 533. Therefore, when the second lens array 52 is viewed from the light incident side, that is, from the side facing the first lens array 51, part of each of the second lenses 521 (second lens 521 indicated by the two-dot chain line in FIG. 5) overlaps with light blockers 535 (or reflection layers 533), as shown in FIGS. 4 and 5. In other words, part of a transmission area through which the light having exited out of a second lens 521 passes is blocked by light blockers 535.

In the second lens array 52, the overlap areas RE, which overlap with the light blockers 535 (or reflection layer 533), are located in opposite end portions in the longitudinal direction of the horizontally elongated second lenses 521 having the aspect ratio described above, that is, in the direction X described above. In other words, in each of the second lenses 521, a roughly square area other than the overlap areas RE is the effective area AR (effective area AR of second lens 521), which allows the light incident on the second lens 521 to be reliably incident on the corresponding polarization separation layer 532.

It is noted that the widthwise direction of the second lenses 521 is the direction Y described above.

### Incident Light Shape Adjustment performed by Anisotropic Diffusion Element

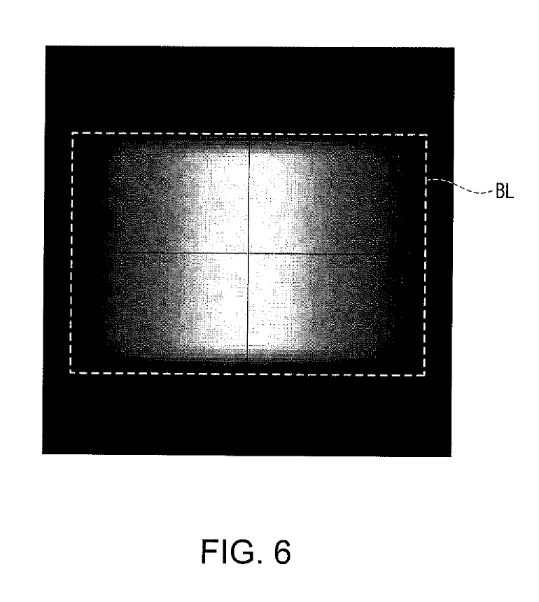

FIG. 6 shows the shape of excitation light BL in a plane orthogonal to the optical axis, which is incident on the anisotropic diffusion element 44.

Light emitted from a typical LD is light having an aspect ratio representing a horizontally elongated shape, so is excitation light emitted from, each of the solid-state light sources 411 described above, which are formed of LDs. Since the light source section 41 superimposes the light fluxes emitted from the plurality of solid-state light sources 411 on one another before outputting them, excitation light BL having an aspect ratio representing a horizontally elongated shape is incident on the anisotropic diffusion element 44, as indicated by the dotted light in FIG. 6.

In a case where no anisotropic diffusion element 44 is provided, the shape of the illumination light WL described above in a plane orthogonal to the optical axis, which is produced on the basis of the excitation light BL having the aspect ratio representing a horizontally elongated shape described above, is similar to the shape of the excitation light BL.

When the thus formed illumination light WL is incident on the first lens array 51, the sub-light fluxes having exited out of the first lenses 511 are light fluxes each having the aspect ratio representing a horizontally elongated shape. In a case where the thus shaped sub-light flux is incident on an area PL indicated by the one-dot chain line in the second lens 521 indicated by the two-dot chain line in FIG. 5, when the sub-light flux passes through the second lens 521 and is incident on the polarization conversion element 53, portions of the light on the opposite ends in the longitudinal direction are blocked by the light blockers 535. Since the blocked light is not used in image formation performed by the light modulators 34, the use efficiency of the light emitted from the light source section 41 decreases, undesirably resulting in a decrease in brightness of a projected image.

To solve the problem, it is conceivable to shorten the distance between the first lens array 51 and the second lens array 52 to allow the sub-light fluxes having the aspect ratio representing a horizontally elongated shape to enter the effective area AR described above, which is indicated by the dotted line in FIG. 5, with the aspect ratio maintained. In this case, since the sub-light flux is not blocked for the most part by the light blockers 535, roughly the entire sub-light flux incident on the second lens 521 is allowed to enter the light incident surface 531A described above and then the polarization separation layer 532.

However, shortening the distance between the first lens array 51 and the second lens array 52 requires shortening the distance between the superimposing lens 54 and the light modulators 34 and superimposing the sub-light fluxes on one another in such a way that the sub-light fluxes converge onto the light modulators 34. In this case, since light in the vicinity of the edge of each of the sub-light fluxes is incident on the light modulators 34 at a large angle of incidence, the modulated light fluxes (image light fluxes) outputted from the light modulators 34 undesirably exit at a large angle of emergence. In this case, the amount of light that does not enter the projection optical apparatus 36 tends to increase, undesirably resulting in a decrease in brightness of a projected image. That is, in this case as well, the problem of a decrease in the use efficiency of the light emitted from the light source section 41 occurs.

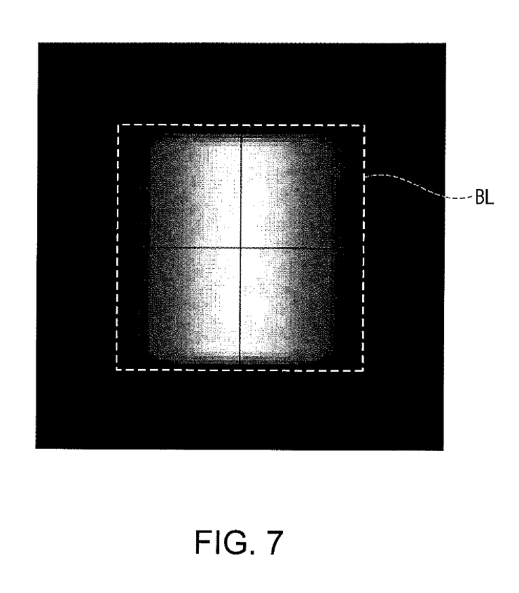

FIG. 7 shows the shape of the excitation light BL in a plane orthogonal to the optical axis, which exits out of the anisotropic diffusion element 44.

To solve the problems described above, in the present embodiment, the anisotropic diffusion element 44 adjusts the shape of the light that exits out of the anisotropic diffusion element 44 in such a way that the shape accords with the effective area AR. That is, the anisotropic diffusion element 44 diffuses the excitation light BL in such a way that the shape of the excitation light BL incident on each of the second lenses 521 is similar to the shape of the effective area AR. Specifically, the anisotropic diffusion element 44 so diffuses the excitation light BL as to be wider in the widthwise direction than in the longitudinal direction so that the longitudinal length dimension of the excitation light BL shown in FIG. 6 is roughly equal to the widthwise length dimension thereof.

As a result, the excitation light BL has a roughly square shape, as indicated by the dotted line in FIG. 7, as in the effective area AR described above does (see FIG. 5).

The anisotropic diffusion element 44 may instead diffuse the excitation light BL in the longitudinal direction as long as the shape of the diffused excitation light BL is roughly similar to the shape of the effective area AR, or the angle of diffusion performed on the excitation light BL that exits out of the anisotropic diffusion element 44 may be so adjusted that the diameter of the excitation light BL is reduced in the longitudinal direction.

Causing the excitation light BL to pass through the anisotropic diffusion element 44 and converting the shape of the excitation light BL into a shape according to the shape of the effective area AR as described above allows the shape of the illumination light WL to be similar to the shape of the effective area AR, as described above. Therefore, the shape of each of the sub-light fluxes produced by the division of the illumination light WL performed by the first lenses 511 of the first lens array 51 is similar to the shape of the effective area AR. Roughly the entirety of each of the sub-light fluxes is thus allowed to enter the entire surface of the effective area AR. The light fluxes having passed through the effective areas AR are superimposed via the polarization conversion element 53 on one another by the superimposing lens 54 on the modulation areas 342, resulting in improvement in the use efficiency of the light emitted from the light source section 41 in image formation.

It is noted that the shape of the sub-light fluxes in the second lenses 521 differs in an exact sense from the shape of the sub-light fluxes in the polarization conversion element 53. However, the shapes of the sub-light fluxes at the two locations can be considered as to be roughly the same as long as the second lens array 52 is located sufficiently close to the polarization conversion element 53. Therefore, when the sub-light fluxes are incident on the entire surfaces of the effective areas AR of the second lenses 521, roughly the entire sub-light fluxes are not blocked by the light blockers 535 but are allowed to enter the polarization conversion element 53. The advantageous effect described above can therefore be reliably provided.

The projector 1 according to the present embodiment described above provides the following advantageous effects.

The anisotropic diffusion element 44 can change the shape of the light emitted from each of the solid-state light sources 411, which are LDs, and incident on the homogenizing apparatus 5 via the wavelength conversion element 4A1 and the diffusive reflection element 48 to a shape according to the shape of the effective area AR of each of the second lenses 521. Therefore, even when each of the solid-state light sources 411 emits light having a shape having the aspect ratio described above representing a horizontally elongated shape, light having a shape similar to the shape of the effective area AR is allowed to enter the first lens array 51. As a result, the sub-light fluxes produced by the first lenses 511 become light fluxes each having a shape similar to the shape of the effective areas AR. Roughly the entire sub-light fluxes are therefore allowed to enter Roughly the entire surfaces of the effective areas AR.

Since the distance between the first lens array 51 and the second lens array 52 does not need to be shortened, the increase in the angle of emergence of the light that exits out of the light modulators 34 toward the projection optical apparatus 36 can be suppressed. As a result, the amount of light that does not enter the projection optical apparatus 36 can be reduced, whereby a decrease in brightness of a projected image can be suppressed. The use efficiency of the light emitted from the light source apparatus 4 (light source section 41) can therefore be improved.

Further, since the anisotropic diffusion element 44 can provide the advantageous effects described above, it is not necessary to employ a homogenizer system having a pair of multi-lens arrays. The configuration of the illuminator 31 can therefore be simplified, whereby the manufacturing cost can be reduced.

The illuminator 31 described above has the afocal system 42, which serves as an optical element that causes the light fluxes emitted from the solid-state light sources 411 and incident via the parallelizing lenses 412 (excitation light) to converge and causes the convergent light fluxes to enter the anisotropic diffusion element 44. Since the afocal system 42 can reduce the light flux diameter of the light incident on the anisotropic diffusion element 44, the size of the anisotropic diffusion element 44 can be reduced, and the size of each optical element (components 44 to 49 and 4A described above, for example) located in the optical path of the light having exited out of the anisotropic diffusion element 44 can be reduced. The size of the illuminator 31 can therefore be reduced.

The homogenizing apparatus 5, which forms the illuminator 31, has the polarization conversion element 53 described above. The polarization conversion element 53 allows the illuminator 31 to output the illumination light WL having polarization directions aligned with one another, whereby the versatility of the illuminator 31 can be improved.

Since the effective area AR of each of the second lenses 521, in accordance with which the anisotropic diffusion element 44 adjusts the shape of the excitation light, is an area that allows the light incident on the second lens 521 to be reliably incident on the polarization separation layer 532, roughly the entire sub-light flux is allowed to enter roughly the entire surface of the effective area AR, whereby roughly the entire sub-light flux having exited out of the second lens 521 is allowed to enter the polarization separation layer 532 without incidence of the sub-light flux on the reflection layer 533 or the light blocker 535. Therefore, light loss can be suppressed, whereby the light use efficiency can be reliably improved.

Since the area illuminated with the light fro(r) the illuminator 31 is the modulation areas 341 of the light modulators 34, the modulation areas 341 can be illuminated with light having a uniform illuminance distribution. Brightness unevenness in a projected image can therefore be suppressed. Further, since it is not necessary to shorten the distance between the first lens array 51 and the second lens array 52, the increase in the angle of emergence of the light fluxes that exit out of the light modulators 34 (image light fluxes) toward the projection optical apparatus 36 is suppressed, as described above. Therefore, a decrease in brightness of a projected image can be suppressed, and the use efficiency of the light from the light source section 41 is improved, whereby the brightness of the projected image can be increased.

### Variations of Embodiment

The invention is not limited to the embodiment described above, and changes, improvements, and other modifications to the extent that the advantage of the invention is achieved fall within the scope of the invention.

The anisotropic diffusion element 44 is configured to diffuse, in the widthwise direction, a light flux incident thereon (excitation light) and having an aspect ratio representing a horizontally elongated shape. The anisotropic diffusion element 44 is, however, not necessarily configured as described above, and an element that reduces the diameter of the light flux in the longitudinal direction may be employed as the anisotropic diffusion element 44. That is, the anisotropic diffusion element 44 only needs to adjust the shape of the light flux that exits out of the anisotropic diffusion element 44 in such a way that the shape is similar to the shape of the effective area AR of each of the second lenses 521.

Further, as the thus functioning anisotropic diffusion element 44, a configuration having a roughened surface roughened differently in two axes that intersect each other in a plane orthogonal to the optical axis has been shown by way of example as well as a configuration having a hologram or multiple lenses. However, the configuration of the anisotropic diffusion element 44 is not limited to those described above and can be changed as appropriate.

Moreover, the anisotropic diffusion element 44 is not necessarily configured to transmit a light flux incident thereon and may be configured to reflect the incident light flux.

The light source apparatus 4 has the afocal system 42 disposed between the light source section 41 having the solid-state light sources 411 and the anisotropic diffusion element 44. However, the thus configured afocal system 42 may be omitted. Further, in place of the afocal system 42, another optical element that causes the light flux from the light source section 41 to be convergent and the convergent light flux to enter the anisotropic diffusion element 44 may be employed.

The effective area AR of each of the second lenses 521 is set as an area that allows the light incident on the second lens 521 to be reliably incident on the polarization separation layer 532. The effective area AR is not necessarily set as described above and may be defined by another factor. For example, in a case where the shape of the modulation areas 341 of the light modulators 34 is not similar to the shape of the second lenses 521, an area of each of the second lenses 521 that allows roughly the entire sub-light flux having passed through the second lens 521 to enter roughly the entire modulation area 341 may be defined as the effective area.

The wavelength conversion apparatus 4A is configured to have the reflection layer 4A4, which reflects the fluorescence produced by the phosphor layer 4A3, when the excitation light is incident through the second pickup lens 49 on the phosphor layer 4A3, toward the second pickup lens 49. That is, the wavelength conversion apparatus 4A is a reflective wavelength conversion apparatus that reflects fluorescence produced by incidence of excitation light. In contrast, the wavelength conversion apparatus 4A may be configured as a transmissive wavelength conversion element that outputs fluorescence along the direction in which excitation light incident on the wavelength conversion element travels. In this case, for example, in place of the reflection layer 4A4, a wavelength selective reflection layer that transmits the excitation, light but reflects the fluorescence may be disposed on the excitation light incident side of the phosphor layer 4A3, and the substrate 4A2 may be a light transmissive substrate.

Further, the wavelength, conversion element 4A1 (substrate 4A2) may not be rotated in a case where the problem of the heat generated in the phosphor layer 4A3 is solved.

The projector 1 includes the three light modulators 34 (34R, 34G, and 34B), each of which has a liquid crystal panel as a light modulator. The invention is, however, also applicable to a projector fewer than or equal to two or greater than or equal to four light modulators.

Each of the light modulators 34 is configured to have a transmissive liquid crystal panel having a light flux incident surface and a light flux exiting surface different from each other and may instead be configured to have a reflective liquid crystal panel having a single surface that serves both as the light incident surface and the light exiting surface. Further, a light modulator that does not use a liquid crystal material but can modulate an incident light flux to form an image according to image information, such as a device using a micromirror, for example, a DMD (digital micromirror device), may be used.

The optical unit 3 is configured to have the optical parts and the arrangement thereof shown in FIGS. 1 and 2 by way of example, but not necessarily, and may employ another configuration and arrangement.

For example, in the illuminator 31, the first retardation plate 43 and the polarization separation apparatus 45 separate part of the excitation light emitted from the light source section 41 and combine the part of the excitation light as blue light with the fluorescence to produce the illumination light WL. In contrast, instead of separating part of the excitation light emitted from the light source section 41 and using the separated excitation light as blue light, another light source section that outputs blue light may be employed in addition to the light source section 41. In this case, the fluorescence produced by the excitation light emitted from the light source section 41 may be combined with the blue light emitted from the other light source section to produce the illumination light WL, or the green light LG and the red light LR separated from the fluorescence may be caused to enter the light modulators 34G and 34R, respectively, and the blue light emitted from the other light source section described above may be caused to enter the light modulator 34B.

The illuminator 31 described above is used in the projector 1, but not necessarily, and can be used in a lighting apparatus, a light source apparatus of an automobile, and other apparatus.

The entire disclosure of Japanese Patent Application No. 2015-211604, filed Oct. 28, 2015 is expressly incorporated by reference herein.

What is claimed is:

1. An illuminator comprising:
a light source apparatus; and
a homogenizing apparatus that homogenizes illuminance of light emitted from the light source apparatus in a plane orthogonal to a central axis of the light,
wherein the homogenizing apparatus includes
a first lens array in which a plurality of first lenses each of which has a shape roughly similar to a shape of an illuminated area are arranged in the orthogonal plane and the plurality of first lenses divide light incident on the first lens array into a plurality of sub-light fluxes, and
a second lens array in which a plurality of second lenses each of which has a shape roughly similar to the shape of the illuminated area are arranged in the orthogonal plane and the plurality of second lenses superimpose the plurality of sub-light fluxes on one another in the illuminated area, and
the light source apparatus includes
a solid-state light source,
a wavelength conversion element that converts a wavelength of light emitted from the solid-state light source, and
an anisotropic diffusion element that is disposed between the solid-state light source and the wavelength conversion element and changes a shape of the emitted light to a shape according to a shape of an effective area of each of the plurality of second lenses.

2. The illuminator according to claim 1,
wherein the light source apparatus further includes an optical element that causes the light emitted from the solid-state light source to converge and causes the convergent light co enter the anisotropic diffusion element.

3. The illuminator according to claim 1,
wherein the homogenizing apparatus includes a polarization conversion element that aligns polarization directions of the plurality of sub-light fluxes with one another,
the polarization conversion element has
a plurality of polarization separation layers that incline with respect to a first direction that is a direction in which the plurality of sub-light fluxes travel,
a plurality of reflection layers that are arranged alternately with the plurality of polarization separation layers along a second direction orthogonal to the first direction, incline with respect to the first direction, and reflect light fluxes reflected off the plurality of polarization separation layers in parallel to a direction in which light fluxes having passed through the plurality of polarization separation layers travel, and
a plurality of retardation layers that are provided in optical paths of the light fluxes having passed through the plurality of polarization separation layers or optical paths of the light fluxes having been reflected off the plurality of reflection layers and convert polarization directions of light fluxes incident on the retardation layers, and
when the second lens array is viewed from a side facing the first lens array, the effective area is an area that does not overlap with the plurality of reflection layers in each of the plurality of second lenses.

4. A projector comprising:
the illuminator according to claim 1;
a light modulator that modulates light emitted from the illuminator; and
a projection optical apparatus that projects the modulated light from the light modulator,
wherein the illuminated area is a modulation area where the light modulator modulates light incident thereon.

5. A projector comprising:
the illuminator according to claim 2;
a light modulator that modulates light emitted from the illuminator; and
a projection optical apparatus that projects the modulated light from the light modulator,
wherein the illuminated area is a modulation area where the light modulator modulates light incident thereon.

6. A projector comprising:
the illuminator according to claim 3;
a light modulator that modulates light emitted from the illuminator; and
a projection optical apparatus that projects the modulated light from the light modulator,
wherein the illuminated area is a modulation area where the light modulator modulates light incident thereon.
